(19) United States
(12) Patent Application Publication
(10) Pub. No.: US 2019/0037051 A1
(43) Pub. Date: Jan. 31, 2019

(54) Technology to transmit GB of data in the air, as they are collected

(71) Applicant: Therese Pimentel, Redwood City, CA (US)

(72) Inventor: Therese Pimentel, Redwood City, CA (US)

(21) Appl. No.: 15/662,267

(22) Filed: Jul. 27, 2017

(51) Int. Cl. H04L 29/06

(52) U.S. Cl. CPC H04L 67/42; H04L 67/02

(57) ABSTRACT

The newer technologies are now placing software in many devices for the home and for commercial use. Data collection devices now include home appliances, commercial systems and electronics. All these newer devices now collect data and often times this data is collected “in the field” where there is no easy means of transmitting the collected data to a central data center (cloud based or otherwise) for analysis, reporting, and re-transmitting. The current invention is a technical solution for a standard means of transmitting data to a cloud-based account via an API for the collection, transmission, transformation, storage, access and reporting of data from these data collection devices.

### CROSS-REFERENCES TO RELATED APPLICATIONS (IF ANY)

None

### BACKGROUND

### 1. Field of the Invention

The present invention relates to a data processing system and technology to transmit GB of data in the air more particularly while it is collected.

### 2. Description of Prior Art

The newer technologies are now placing software in many devices for the home and for commercial use.

Many of the newer appliances now come with software that monitors the electronics like temperature, door open/close, water levels, etc.

Many commercial product and systems also come with monitoring software such as water irrigation systems, heating systems, HVAC systems, Airplanes, and drones, All these newer devices now collect data and often times this data is collected “in the field” where there is no easy means of transmitting the collected data to a central data center (cloud based or otherwise) for analysis, reporting, and re-transmitting.

There is still room for improvement in the art.

### SUMMARY OF THE INVENTION

This application is a technical solution for a standard means of transmitting data to a cloud-based account via an API for the collection, transmission, transformation, storage, access and reporting of data from these data collection devices.

The process is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 shows an overview of how Users access the system; and

FIG. 2 shows a Diagram of the data being transmitted.

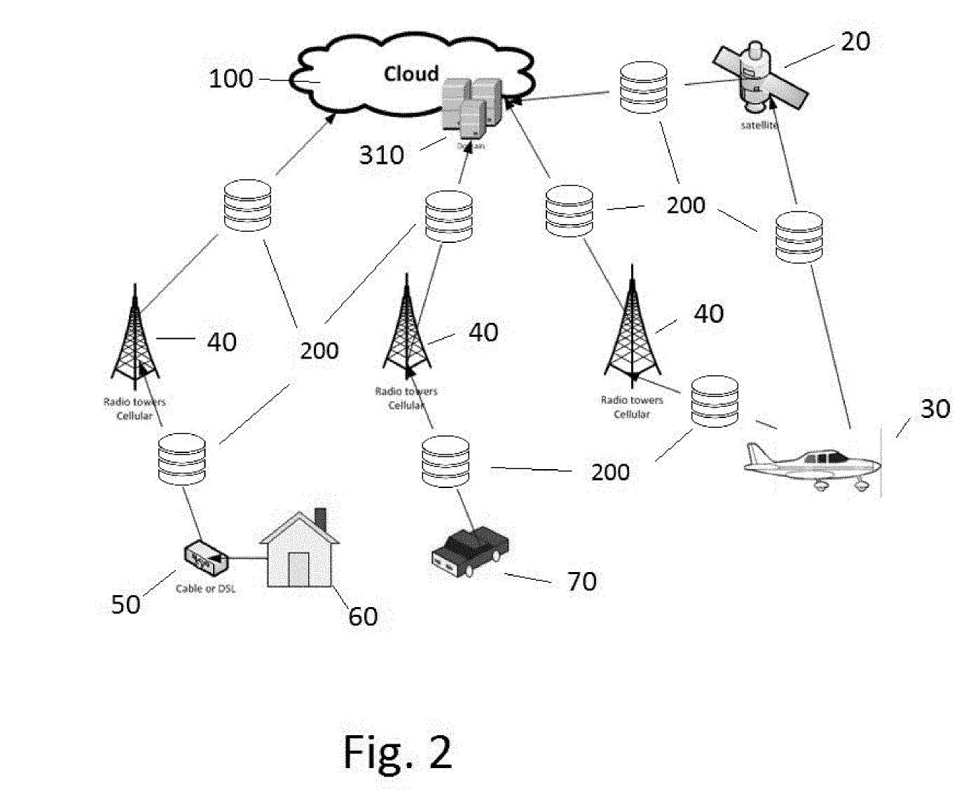

### DESCRIPTION OF THE PREFERRED EMBODIMENT

There are a number of significant design features and improvements incorporated within the invention.

The present invention relates to a process and data processing system 101 which is a technical solution for a standard means of transmitting data to a cloud-based account via an application programming interface for the collection, transmission, transformation, storage, access and reporting of data from these data collection devices. An application programming interface (API) is a set of routines, protocols, and tools for building software and applications

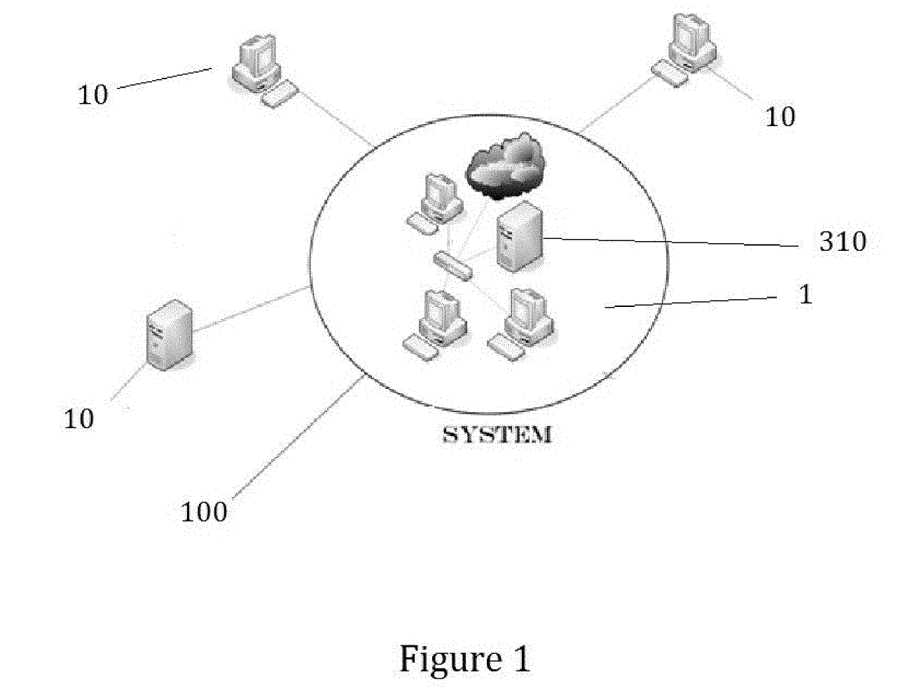

FIG. 1 displays the preferred embodiment of the system architecture 101 accessed through an Internet, Intranet and/or Wireless network 500. However, the system could be implemented on a client/server architecture as well. Most typically, users of the system 101 are managers within their organization. However, users of the system 101 are not required to be managers.

In FIG. 1, the system 101 is accessed from a user's computing device 10 through a web browser over HTTP and/or HTTPS protocols 500. A computing device 10 that can access the system 101 must have some version of a CPU, CPU memory, local hard disk, keyboard and display unit. A printer or multiple printers may also be included but are not required. The computing device 10 can be any desktop, laptop, tablet, smart phone or general purpose computing device with an appropriate amount of memory suitable for this purpose and an active connection to the Internet 500. Computing devices like this are well known in the art and are not pertinent to the invention.

The system 101 software and database reside in the system's local server architecture 100. The system 101 operates on one or more application servers 40. This application is a technical solution for a standard means of transmitting data to a cloud-based account via an API for the collection, transmission, transformation, storage, access and reporting of data from these data collection devices.

The system 101, data and processing code can reside in the non-transitory memory 310 of the one or more computing devices. The system 1 in the preferred embodiment would be written to act like a smart phone application (app) where the different apps can communicate with each. The system 101 may work with a central server in parallel which each computing device 10 or smartphone communicating with others within the system 101.

The system 101, data and processing code can reside in the non-transitory memory 310 of the one or more computing devices. The system 1 in the preferred embodiment would be written to act like a smart phone application (app).

The newer technologies are now placing software in many devices for the home and for commercial use. Many of the newer appliances now come with software that monitors the electronics like temperature, door open/close, water levels, etc. This is also true for commercial devices and systems such as water irrigation systems, heating systems, HVAC systems, Airplanes, and drones.

All these newer devices now collect data and often times this data is collected “in the field” where there is no easy means of transmitting the collected data to a central data center (cloud based or otherwise) for analysis, reporting, and re-transmitting.

The Data Collection will be at the starting point. Data will be pre-processed at the source to make the bandwidth as small and efficient. A new standard API will be used that will allow systems to connect and send data to the cloud account.

The data transmission will utilize wireless (WI-FI) or cell towers 40 in the area. An account with a carrier will be needed. The collection device will have an API that will search for the nearest Wi-Fi or cell tower. Once located, it will transmit data that has already been appropriately formatted for transmission as specified by this new API.

Data Collection, the data is collected at the starting points such as homes 60, cars 70, airplanes 30 or any other end point that collects data. The data can be transmitted through cable or DSL 50, cellular towers 40 and/or satellites 20.

Data 200 will be received at the Storage site (either in the cloud 100 or at a specific data center 310 or private cloud). Once data 200 is stored, it can be viewed via the integrated Business intelligence (BI) tool or the provided reporting mechanism. Business intelligence (BI) can be described as a set of techniques and tools for the acquisition and transformation of raw data into meaningful and useful information for business analysis purposes. This reporting mechanism available as a web based application 1 or a mobile app, will have basic standard reports that can be customized for the clients for additional professional services outside the standard product purchase.

System set up is as follows:

Purchase a data only account with a data carriers or set up a pre-owned set of accounts for use with these applications and charged in a SAAS model. Set up software at end point for the receipt and storage of the information. Install the API at the collection point device. The API will process the data and format it for transmission. The transmission can be via TCP/IP/UDP. The data will be structured for minimal bandwidth usage

The API will have error connection handling for transmission disruptions (e.g. loss of connection, DNS error handling) as well as message queuing, offline capability to store data 200 and transmit when there is available connectivity.

The system will have a database pre-defined with a standard set of tables to store device data. This database will be customizable to fit any data types collected with options for adding columns and tables. During installation, the user will be provided with the opportunity to create the columns and/or tables needed or re-run this program after installation.

The system 1 may opt to connect to an analytics tool like tableau or other BI products to read/pull data for reporting or set up the database to be use standard SQL to pull the data.

### CONCLUSION

Although the present invention has been described in considerable detail with reference to certain preferred versions thereof, other versions are possible. Therefore, the point and scope of the appended claims should not be limited to the description of the preferred versions contained herein. The system is not limited to any particular programming language, computer platform or architecture.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A method:
having a system that resides in the electronic memory of a computing server;
having data collection at a starting point;
Pre-processing the data at the starting point; and
using an application programming interface that connects and send data from the starting point to a cloud account.

2. A method according to claim 1 in having a plurality of starting points.
